(19) United States
(12) Patent Application Publication
(10) Pub. No.: US 2026/0023302 A1
(43) Pub. Date: Jan. 22, 2026

(54) MATTE BOX KIT

(71) Applicant: TILTA INC., Burbank, CA (US)

(72) Inventors: Shuangqiang YANG, Shenzhen (CN); Wenping ZENG, Shenzhen (CN); Kefeng ZHOU, Shenzhen (CN)

(21) Appl. No.: 19/269,851

(22) Filed: Jul. 15, 2025

(30) Foreign Application Priority Data
Jul. 17, 2024 (CN) 2024217037835

(51) Int. Cl. G03B 11/04

(52) U.S. Cl. CPC G03B 11/045

(57) ABSTRACT

The present disclosure provides a matte box kit, including a matte box body, a mounting assembly, a first magnetic attachment, and a second magnetic attachment. The matte box body includes a first connection structure and a first light path extending along a first direction. The mounting assembly is configured to secure a lens and includes a second connection structure and a second light path extending along the first direction. The first magnetic attachment is arranged on the matte box body, and the second magnetic attachment is arranged on the mounting assembly. The first and second magnetic attachments are mutually attracted to pre-align and pre-connect the matte box body and the mounting assembly. The first connection structure and the second connection structure form a detachable fixation, aligning the first light path, the second light path, and the lens along the first direction such that they are opposed and in communication.

### CROSS-REFERENCE TO RELATED APPLICATIONS

The present application for patent claims priority to and the benefit of pending Chinese Application No. 2024217037835, filed on Jul. 17, 2024, and hereby expressly incorporated by reference herein as if fully set forth below in its entirety and for all applicable purposes.

### TECHNICAL FIELD

The present disclosure pertains to the field of photographic equipment, and more particularly, to a matte box kit.

### INTRODUCTION

With the growing prevalence of smartphones and camera devices, industries such as photography, videography, and live streaming have experienced significant expansion. To stabilize cameras or smartphones during shooting, auxiliary devices such as tripods and gimbals are widely employed.

A matte box is a standard photographic accessory mounted in front of a lens and can be constructed from various materials, including metal, hard plastic, and soft rubber. It effectively blocks non-imaging light from entering during backlight, sidelight, or flash photography, thereby preventing haze. In filming applications, different optical filters can be mounted on the matte box to achieve desired imaging effects in conjunction with light filters, lens hoods, and other components as required.

Conventional matte boxes on the market typically rely on bolts or screws for assembly and disassembly when connecting to other structural components, facilitating ease of use, storage, and transportation. However, existing designs still suffer from cumbersome assembly and disassembly processes, resulting in a suboptimal user experience.

### BRIEF SUMMARY

Aspects of the present disclosure provide a matte box kit that enables convenient assembly and improved ease of use.

Some aspects of the present disclosure provide a matte box kit including:
a matte box body having a first connection structure and a first light path extending along a first direction;
a mounting assembly configured to mount and secure a lens, the mounting assembly including a second connection structure and a second light path extending along the first direction;
a first magnetic attachment disposed on the matte box body; and
a second magnetic attachment disposed on the mounting assembly;
wherein the first magnetic attachment and the second magnetic attachment are mutually attracted to pre-align and pre-connect the matte box body and the mounting assembly, and wherein the first connection structure and the second connection structure form a detachable fixation such that the first light path, the second light path, and the lens are aligned and in optical communication along the first direction.

### BRIEF DESCRIPTION OF THE DRAWINGS

FIG. 1 is a diagram illustrating a view of a matte box kit with an optical filter installed according to some aspects of the present disclosure.

FIG. 2 is a diagram illustrating an exploded view of the matte box kit according to some aspects of the present disclosure.

FIG. 3 is a diagram illustrating another perspective view of the matte box kit of FIG. 2.

FIG. 4 is a diagram illustrating a matte box body according to some aspects of the present disclosure.

FIG. 5 is a diagram illustrating another perspective view of the matte box body of FIG. 4.

FIG. 6 is a diagram illustrating a left-side view of the matte box body of FIG. 5.

FIG. 7 is diagram illustrating a first connection structure according to some aspects of the present disclosure.

FIG. 8 is a diagram illustrating an exploded view of the first connection structure of FIG. 7.

FIG. 9 is a diagram illustrating an exploded view of the matte box body and a mounting assembly according to some aspects of the present disclosure.

FIG. 10 is a diagram illustrating the first connection structure of FIG. 9.

FIG. 11 is a diagram illustrating the mounting assembly with an optical filter installed according to some aspects of the present disclosure.

FIG. 12 is a diagram illustrating a filter mount according to some aspects of the present disclosure.

FIG. 13 is a diagram illustrating another perspective view of the filter mount of FIG. 12.

FIG. 14 is a diagram illustrating a lens mount according to some aspects of the present disclosure.

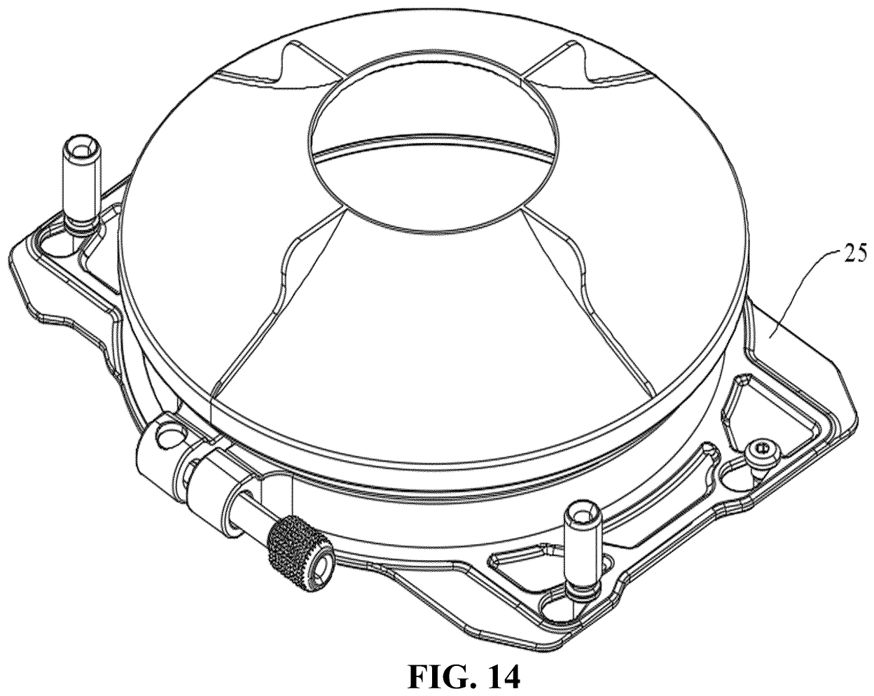

FIG. 15 is a diagram illustrating an assembled view of the matte box body and a light baffle according to some aspects of the present disclosure.

FIG. 16 is a diagram illustrating another perspective view of the matte box body and light baffle FIG. 15.

FIG. 17 is a diagram illustrating the light baffle according to some aspects of the present disclosure.

FIG. 18 is a diagram illustrating another perspective view of the light baffle of FIG. 17.

FIG. 19 is a diagram illustrating the matte box kit with an angle adjustment apparatus and a clamping structure according to some aspects of the present disclosure.

FIG. 20 is a diagram illustrating an assembled view of the angle adjustment apparatus and the clamping structure in some aspects of the present disclosure.

FIG. 21 is a diagram illustrating the angle adjustment apparatus in some aspects of the present disclosure.

FIG. 22 is a diagram illustrating an exploded view of the angle adjustment apparatus of FIG. 21.

FIG. 23 is a diagram illustrating an internal design of the clamping structure with partial structures omitted according to some aspects of the present disclosure.

FIG. 24 is a diagram illustrating another perspective view of the clamping structure of FIG. 23.

### REFERENCE NUMERALS

100—matte box kit; 10—matte box body; 11—first magnetic attachment; 12—first connection structure; 121—elastic member; 122—latch component; 123—latch projection; 1231—guide bevel; 124—pivot shaft; 125—limit projection; 13—first light path; 14—mounting base plate; 15—limiting part; 16—threaded support bracket; 17—first boss; 18—second recess; 19—stop rib; 20—mounting assembly; 21—second magnetic attachment; 22—second connection structure; 23—second light path; 24—filter mount; 241—filter slot; 242—clearance notch; 243—mounting bracket; 244—positioning pin; 245—base layer; 246—sub-layer; 25—lens mount; 26—clamping member; 27—second boss; 28—first recess; 29—limit slot; 30—light baffle; 31—connection shaft; 40—mounting block; 50—locking screw; 60—angle adjustment apparatus; 61—first connector; 62—second connector; 621—limit stop; 622—first link unit; 623—second link unit; 63—adjustment assembly; 631—first adjustment pivot; 632—second adjustment pivot; 633—adjuster; 70—clamping structure; 71—main bracket; 711—clamp holder; 712—mounting groove; 72—linkage assembly; 721—locking block; 722—linkage adjuster; 723—locking knob; 724—spring; 725—linkage block;
200—optical filter.

### DETAILED DESCRIPTION

To clarify the objectives, technical solutions, and aspects of the present disclosure, the following detailed description is provided in conjunction with the accompanying drawings and exemplary embodiments. It should be understood that the specific embodiments described herein are merely for illustrative purposes and do not limit the scope of the present disclosure.

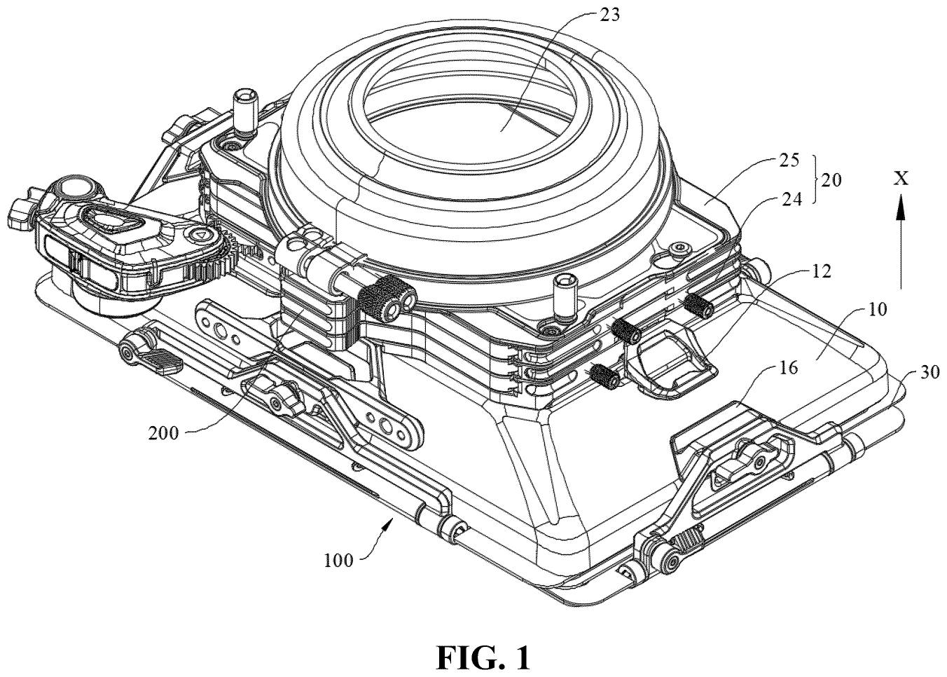

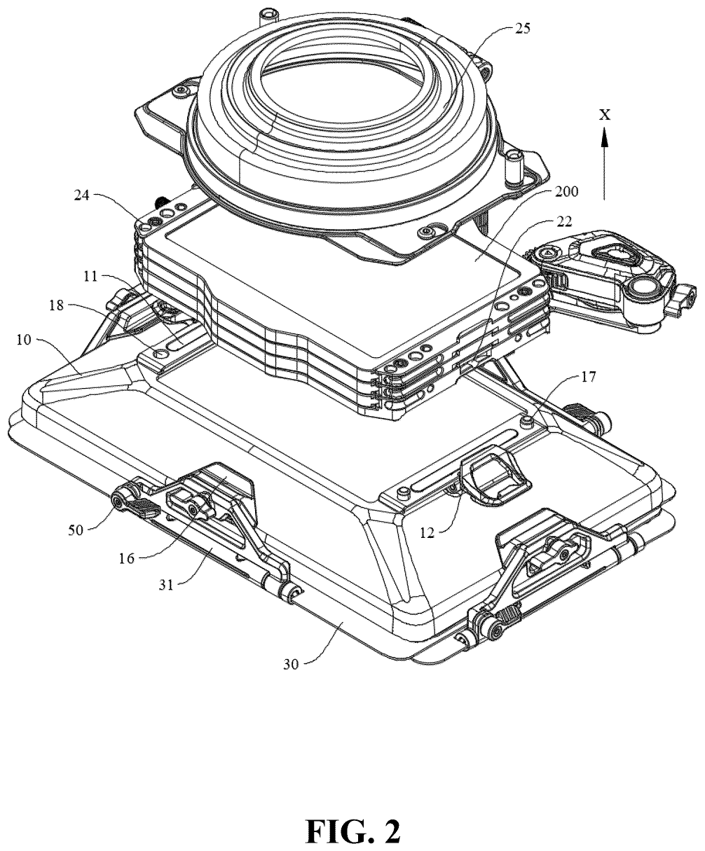

Referring to FIGS. 1 and 2, in some aspects, the matte box kit 100 includes a matte box body 10, a mounting assembly 20, a first magnetic attachment 11, and a second magnetic attachment 21. The matte box body 10 has a first connection structure 12 and a first light path 13 penetrating along a first direction. The mounting assembly 20 is configured to mount and secure a lens, and has a second connection structure 22 and a second light path 23 penetrating along the first direction. The first magnetic attachment 11 is disposed on the matte box body 10, and the second magnetic attachment 21 is disposed on the mounting assembly 20. The first magnetic attachment 11 and the second magnetic attachment 21 are mutually attracted to pre-align and pre-connect the matte box body 10 and the mounting assembly 20. The first connection structure 12 and the second connection structure 22 form a detachable fixation to ensure that the first light path 13, the second light path 23, and the lens are aligned oppositely and communicated along the first direction. The first direction corresponds to the thickness direction of the matte box body 10 and the mounting assembly 20 (X-direction in FIG. 1), ensuring that the first light path 13 and the second light path 23 are aligned coaxially and aligned oppositely when the matte box kit 100 is fully assembled.

In some aspects, the first magnetic attachment 11 on the matte box body 10 and the second magnetic attachment 21 on the mounting assembly 20 are magnetically attracted to each other, enabling quick pre-alignment and pre-connection. This allows the user to perform other operations, such as fine-tuning the relative position of the mounting assembly 20 and the matte box body 10 or engaging the first connection structure 12 with the second connection structure 22, without needing to manually hold the components. This design reduces assembly difficulty. Subsequently, the first connection structure 12 and the second connection structure 22 are aligned and detachably fixed to complete the assembly of the matte box kit 100. The mounting assembly 20 is fixed to the lens so as to mount the entire matte box kit 100 onto the lens, ensuring that the first light path 13 and the second light path 23 are aligned with the lens. Compared to other designs, the present disclosure provides a rapid assembly/disassembly solution through pre-alignment, pre-connection, and detachable fixation, offering the technical advantages of convenience and case of use.

In some aspects, to improve the alignment accuracy of the first magnetic attachment 11 and the second magnetic attachment 21, the matte box body 10 and the mounting assembly 20 can be provided with positioning features for guidance. For example, in some examples, both the matte box body 10 and the mounting assembly 20 can have pin holes for precise pre-alignment using removable positioning pins. In other examples, the matte box body 10 can have a recess matching the end of the mounting assembly 20, enabling the end of the mounting assembly 20 to directly engage with the recess for positioning. Similarly, in some examples, the mounting assembly 20 can have a recess near its end facing the matte box body 10, and a portion of the matte box body 10 can be embedded in the recess to facilitate pre-alignment.

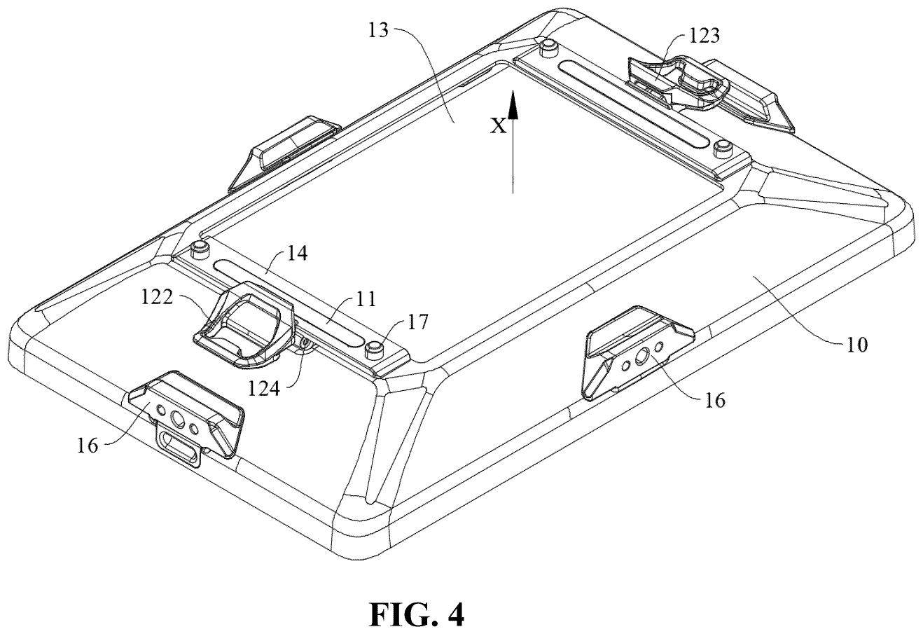

In some aspects, to improve the alignment accuracy of the first magnetic attachment 11 and the second magnetic attachment 21 while maintaining the structural integrity of the matte box body 10 and the mounting assembly 20, the matte box body 10 can have at least one first boss 17, and the mounting assembly 20 can have at least one first recess 28, wherein the first boss 17 and the first recess 28 are correspondingly matched. In some aspects, the matte box body 10 can have at least one second recess 18, and the mounting assembly 20 can have at least one second boss 27, wherein the second recess 18 and the second boss 27 are correspondingly matched. In other words, the matte box body 10 can have only the first boss 17, only the second recess 18, or both the first boss 17 and the second recess 18. In some example (FIG. 4), the matte box body 10 has four first bosses 17, and the mounting assembly 20 has four corresponding first recesses 28. In other example (FIG. 2), the matte box body 10 has two first bosses 17 and two second recesses 18, while the mounting assembly 20 has two corresponding first recesses 28 and two second bosses 27.

In different implementations, the total number of first bosses 17 and/or second recesses 18 on the matte box body 10 can be adjusted as needed, as long as the pre-alignment between the mounting assembly 20 and the matte box body 10 is achieved. This pre-alignment can be a precise alignment that directly positions the first connection structure 12 and the second connection structure 22, or it can be a general positioning for the mounting assembly 20 and the matte box body 10. For example, in some examples, the matte box body 10 can have only one first boss 17, and the mounting assembly 20 can have only one first recess 28. If the extension direction of the first boss 17 is the first direction, the first boss 17 and the first recess 28 can be designed to restrict relative rotation, such as by using an elliptical, polygonal, or irregularly shaped boss. Alternatively, in some examples, the extension direction of the first boss 17 can intersect with the first direction at an angle, and the contact between the end surfaces of the mounting assembly 20 and the matte box body 10 ensures general positioning, allowing the first connection structure 12 and the second connection structure 22 to align easily for quick fixation. In other examples, the extension direction of the first boss 17 or the second boss 27 can be perpendicular to the first direction, enabling the mounting assembly 20 and the matte box body 10 to slide into alignment via the matching first boss 17 and first recess 28.

In some examples (FIG. 4), the matte box body 10 has multiple first bosses 17 spaced apart, and the mounting assembly 20 has correspondingly spaced first recesses 28. The first bosses 17 and first recesses 28 engage along the first direction, where “multiple” refers to two or more. The first bosses 17 can be cylindrical, elliptical, polygonal, or irregularly shaped. The arrangement of multiple first bosses 17 and equal amount of first recesses 28 (restricting the relative positions of the matte box body 10 and the mounting assembly 20) ensures anti-rotation between the matte box body 10 and the mounting assembly 20, allowing the first connection structure 12 and the second connection structure 22 to align directly without additional adjustments, thereby simplifying assembly. Since the first magnetic attachment 11 and the second magnetic attachment 21 can pre-connect the matte box body 10 and the mounting assembly 20, the user's hands are freed for other operations, such as engaging the first connection structure 12 and the second connection structure 22.

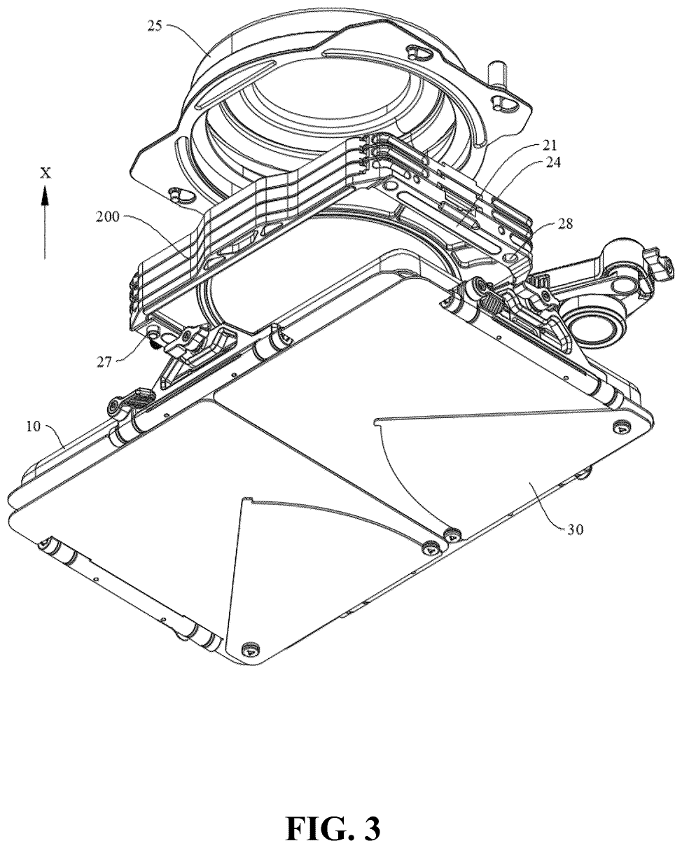

To further enhance user experience and reduce assembly difficulty, in some examples (FIGS. 2 and 3), the first magnetic attachment 11 is disposed on the end of the matte box body 10 facing the mounting assembly 20, and the second magnetic attachment 21 is correspondingly disposed on the end of the mounting assembly 20 facing the matte box body 10. This arrangement can maximize the magnetic attraction force by positioning the first magnetic attachment 11 and the second magnetic attachment 21 as close to each other as possible, ensuring stable pre-connection between the mounting assembly 20 and the matte box body 10 under normal conditions. In some examples, the engagement direction of the first boss 17 and the first recess 28 can also be aligned with the first direction, making it consistent with the magnetic attraction direction. This ensures that the positioning and magnetic attraction forces act in the same direction, allowing the mounting assembly 20 to magnetically attach to the matte box body 10 instantly when the first boss 17 and the first recess 28 are aligned. This optimizes the assembly structure of the matte box kit 100 for faster pre-alignment and pre-connection.

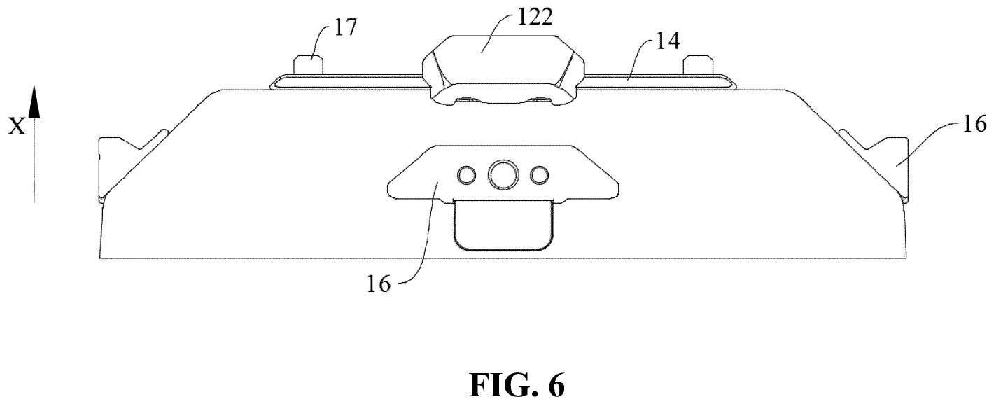

Referring to FIGS. 4-6, in some examples, the matte box body 10 includes four side walls that enclose a first light path 13 with a rectangular cross-section. From an end distal to the mounting assembly 20 to an end proximal to the mounting assembly 20, the cross-sectional area of the first light path 13 gradually decreases. The four side walls each have an inwardly extending connecting edge at the second end of the matte box body 10 to form a connecting end face for attaching to the mounting assembly 20. Four first bosses 17 are spaced circumferentially around the connecting end face of the matte box body 10, with two first bosses 17 arranged on the connecting edges of each pair of opposing side walls. This configuration enables more precise alignment of the relative positions of the matte box body 10 and the mounting assembly 20 while increasing the connection area between the matte box body 10 and the mounting assembly 20, thereby enhancing connection strength and improving assembly stability.

In some examples, to ensure a stable connection between the mounting assembly 20 and the matte box body 10, both the first connection structure 12 and the second connection structure 22 include multiple units. Two first connection structures 12 are oppositely disposed on the matte box body 10 and located on either side of the first light path 13, while two second connection structures 22 are oppositely disposed on corresponding sides of the mounting assembly 20. This multi-point connection ensures uniform stability across all connection points. At least two first connection structures 12 are arranged on opposing sides, and at least two second connection structures 22 are correspondingly disposed on opposing sides of the mounting assembly 20, ensuring a balanced distribution of fastening forces in at least one direction.

The detachable fixation formed by the first connection structure 12 and the second connection structure 22 can employ any existing detachable connection method, such as threaded connections, fastening connections, snap-fit connections, or magnetic connections. Fastening connections refer to those achieved via bolts, screws, or similar structures.

In some examples, to further enhance the convenience of the matte box kit 100 and reduce assembly difficulty, the first connection structure 12 and the second connection structure 22 form a quick-release fixation for connecting the mounting assembly 20 and the matte box body 10. The quick-release fixation enables connection and disassembly without auxiliary tools, including but not limited to magnetic connections, clamping connections, snap-fit connections, or screws with integrated knobs.

Snap-fit connections are a cost-effective, efficient, and convenient method widely used in mechanical applications. This example does not specifically limit the type of snap-fit connection used between the mounting assembly 20 and the matte box body 10. Any feasible snap-fit structure available from relevant techniques, such as cantilever snaps or ball-type snaps, can be adopted.

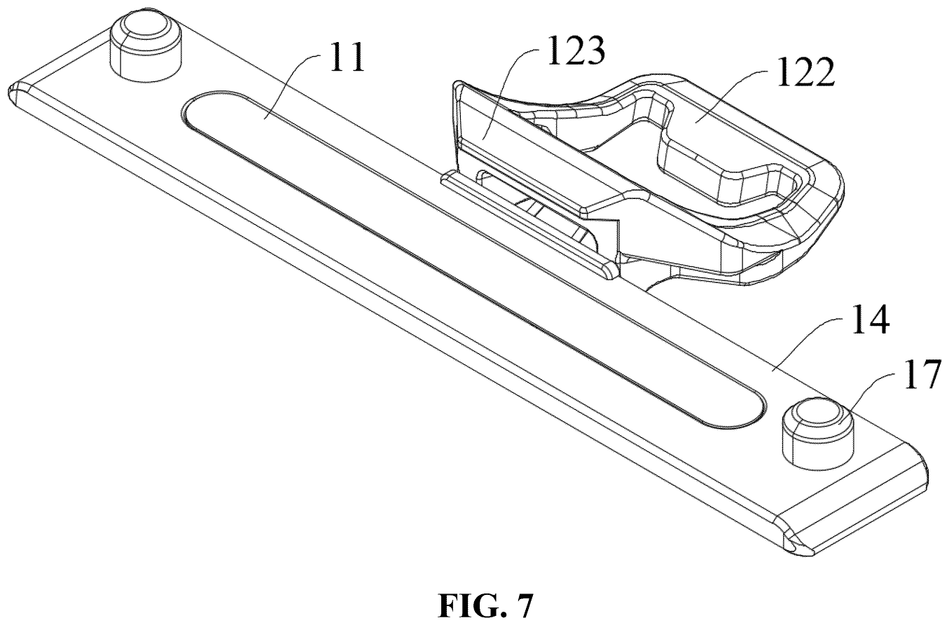

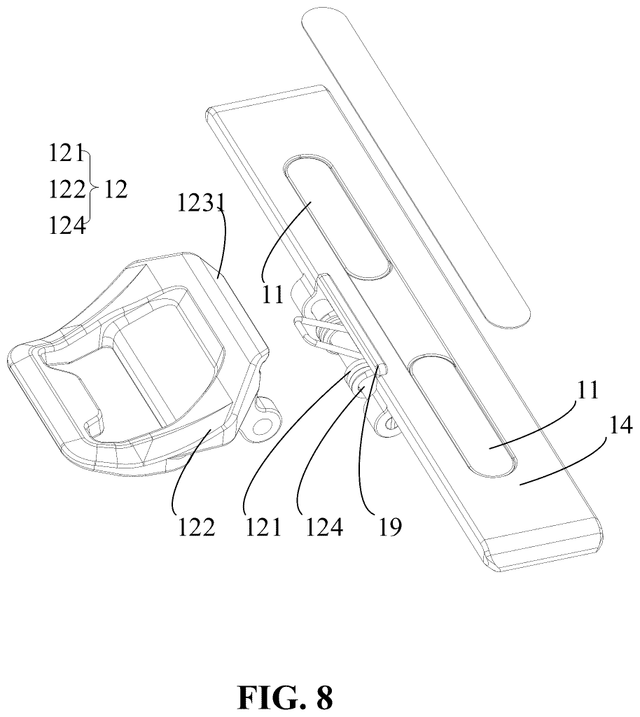

In some examples (FIGS. 7-8), the first connection structure 12 includes an elastic member 121 and a latch component 122. The latch component 122 can be movably disposed on the matte box body 10 and includes a latch projection 123. The second connection structure 22 is a latch groove (e.g., a slot or a channel). The elastic member 121 acts on the latch component 122 to engage the latch projection 123 into the latch groove, preventing disengagement. The latch component 122 is movable within a certain range. When subjected to an external force, it overcomes the elastic force of the elastic member 121, causing the latch projection 123 to move away from the center of the first light path 13, thereby creating space for alignment between the mounting assembly 20 and the matte box body 10 without interfering with the magnetic attraction between the first magnetic attachment 11 and the second magnetic attachment 21. In the absence of external force applied to the latch component 122, the elastic member 121 drives the latch component 122 toward the latch groove of the mounting assembly 20, maintaining engagement between the latch component 122 and the latch groove. Simply by pressing or releasing the latch component 122, the mounting assembly 20 and the matte box body 10 can be quickly assembled or disassembled, meeting frequent installation and removal needs.

In other examples, the first connection structure 12 can alternatively be a latch groove, while the second connection structure 22 includes the elastic member 121 and the latch component 122. The structural details are similar to the above description and are not repeated here. In such cases, the connection method and principle remain unchanged (compared to the structure illustrated in FIG. 7), only the positions are altered, achieving the same quick-release functionality.

The selection and force magnitude of the elastic member 121 can be adjusted based on practical requirements. For example, in some examples, the latch component 122 can slide on the matte box body 10, with the elastic member 121 being a compression spring (e.g., cylindrical helical spring, ring spring, disc spring, or torsion spring). The compression spring connects the latch component 122 and the matte box body 10, pressing the latch projection 123 into the latch groove for engagement when no external force is applied, thereby restricting relative movement between the mounting assembly 20 and the matte box body 10 in all directions.

In some examples (FIGS. 7-8), the elastic member 121 is a torsion spring, and the latch component 122 includes the latch projection 123. The torsion spring and the latch component 122 are pivotally mounted on the matte box body 10 via a pivot shaft 124, with the torsion spring acting on both the matte box body 10 and the latch component 122. The latch groove is disposed on the side of the mounting assembly 20 to accommodate the latch projection 123.

In some examples (FIG. 8), the latch projection 123 has a guide bevel 1231 on a side facing away from the matte box body 10. The end of the guide bevel 1231 closer to the first light path 13 is positioned nearer to the matte box body 10 along the first direction than the end facing away from the first light path 13, forming a tapered structure at the end of the latch projection 123 facing away from the matte box body 10. The matte box body 10 further includes a stop rib 19 at its end facing the mounting assembly 20, located on the side of the latch component 122 closer to the first light path 13. In the absence of external force, the stop rib 19 abuts the latch component 122 to bear the elastic force from the elastic member 121, preventing the latch component 122 from rotating further toward the center of the first light path 13 after resetting. The mounting assembly 20 has a clearance notch 242 at its end facing the matte box body 10 to avoid the stop rib 19. This design guarantees that when the matte box body 10 is connected to the mounting assembly 20, the groove surface of the clearance notch 242 on the mounting assembly 20 will interact with the guide bevel 1231 that extends into the clearance notch 242. This interaction prompts the latch component 122 to rotate away from the center of the first light path 13, thereby facilitating the self-installation of the matte box body 10 and the mounting assembly 20. In some aspects, the stop rib 19 is generally parallel to the first direction, ensuring that the contact surface of the latch component 122 is also generally parallel to the first direction. When the mounting assembly 20 is brought close to the matte box body 10, a portion of the latch projection extends into the clearance notch. The groove surface of the clearance notch 242 on the mounting assembly 20 then exerts pressure against the guide bevel 1231 in the first direction. The guide bevel 1231 converts the axial force into a lateral thrust, causing both the latch component 122 and the latch projection 123 to rotate away from the center of the first light path 13. Following this operation, the mounting assembly 20 can be further pressed downward towards the matte box body 10. Once the mounting assembly 20 and the matte box body 10 come into contact, the latch projection 123 fully disengages from the clearance notch 242. At this point, the torsion spring resets the latch component 122, securing the latch projection 123 in the latch groove for quick installation. With this configuration, during installation, the user can simply hold the mounting assembly 20 near the matte box body 10 without the need to manually press the latch component 122, thereby enhancing the overall installation convenience.

Along the first direction, the stop rib 19 is located on the side of the latch projection 123 facing away from the mounting assembly 20. The clearance notch 242 has two openings: one facing the matte box body 10 along the first direction, and the other on the side of the mounting assembly 20, facing the latch component 122. In some examples, to reduce wear between the guide bevel 1231 and the groove surface of the clearance notch 242, the groove surface of the clearance notch 242 corresponding to the matte box body 10 along the first direction can be inclined to match the guide bevel 1231.

In some examples, both the latch projection 123 and the latch groove have square profiles. The surface of the latch projection 123 closer to the matte box body 10 along the first direction is flat, while the top and peripheral surfaces are chamfered. The opening edges of the latch groove are also chamfered to facilitate alignment and assembly between the latch projection 123 and the latch groove. The two opposing groove walls along the first direction restrict the latch projection 123 for precise positioning of the latch projection 123 along the first direction, while the other two groove walls provide general circumferential alignment between the latch projection 123 and the matte box body 10.

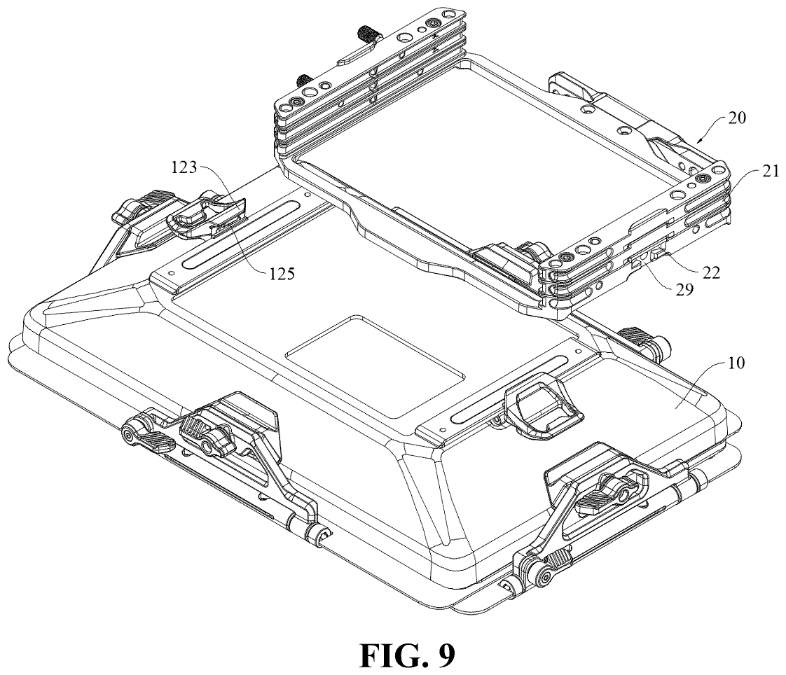

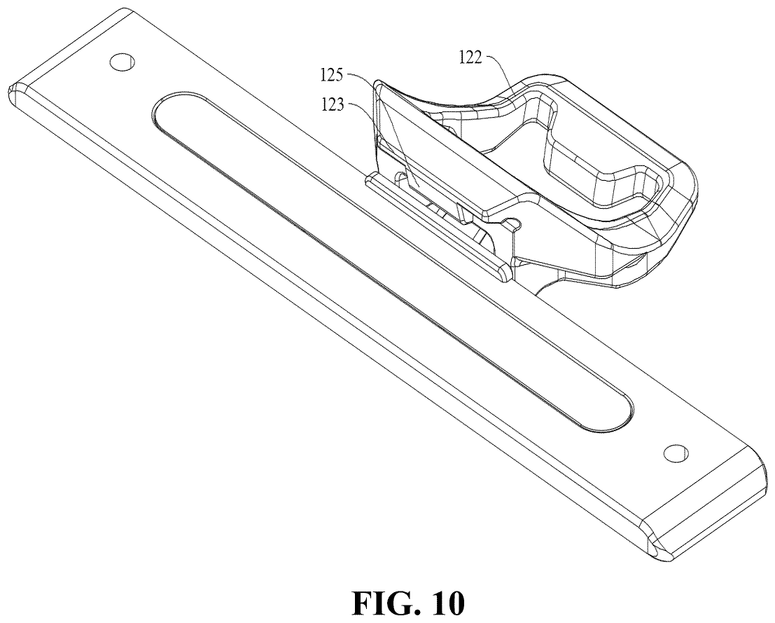

In some examples, to further restrict the relative position between the latch projection 123 and the latch groove, thereby effectively preventing the latch projection 123 from wobbling circumferentially around the matte box body 10, referring to FIGS. 9 and 10, the latch component 122 further includes a limit projection 125, and the mounting assembly 20 further includes a limit slot 29, which communicates with the latch groove. Along the first direction, the limit projection 125 is disposed on a side of the latch projection 123 closer to the matte box body 10, and the limit slot 29 is disposed on a side of the latch groove closer to the matte box body 10. The length of the latch groove is greater than that of the limit slot 29, forming a stepped surface along the first direction. In this example, the groove wall of the latch groove near the limit slot 29 in the first direction constitutes the stepped surface. The length of the limit slot 29 matches that of the limit projection 125, and the groove walls of the limit slot 29 clamp the side walls of the limit projection 125 to position it within the limit slot 29. Meanwhile, the presence of the limit slot 29 does not affect the positioning of the latch projection 123 in the first direction, as the latch projection 123 remains positioned by the two opposing groove walls of the latch groove along the first direction.

In some examples (FIG. 9), the side of the mounting assembly 20 where the latch groove and limit slot 29 are located is a plane parallel to the first direction. Both the limit slot 29 and the latch groove are rectangular, with the length direction of the limit slot 29, the first direction, and the depth direction of the limit slot 29 being mutually perpendicular. The dimension of the limit slot 29 in the first direction is understood as its width. Similarly, the length direction of the latch groove, the first direction, and the depth direction of the latch groove are mutually perpendicular, with the dimension of the latch groove in the first direction understood as its width. In some examples, the stepped surface can exist on only one side along the length direction of the limit slot 29 and latch groove, meaning one end of the latch groove aligns with one end of the limit slot. In other examples, the stepped surface can exist on both sides, meaning the two ends of the limit slot 29 are located between the two ends of the latch groove (FIG. 9).

In some examples (FIGS. 9 and 10), along the first direction, the limit slot 29 is located between the latch groove and the clearance notch 242, with its two ends communicating with the latch groove and the clearance notch 242, respectively.

In some examples, the axis of the torsion spring and the pivot shaft 124 can be parallel to the first direction. To enhance the installation strength of the torsion spring and latch component 122, a reinforced mounting base can be provided on the matte box body 10, with the latch component 122 movably installed on it.

To capitalize on the structural characteristics of the matte box body 10 and minimize the space occupied by the latch component 122, thereby optimizing the overall structure of the matte box kit 100, in some examples, both the axis of the torsion spring and the pivot shaft 124 are oriented perpendicular to the first direction. This arrangement effectively reduces the overall dimension of the latch component 122 in the first direction and utilizes the funnel-shaped structure of the matte box body 10 to provide clearance for the rotation of the latch component 122 while constraining its rotation angle for easier force application.

Referring to FIG. 4, in some examples, to strike a balance between connection stability and operational convenience, the first connection structure 12 includes two latch components 122 and two elastic members 121, with the two latch components 122 positioned on opposite side walls of the matte box body 10. Correspondingly, the second connection structure 22 includes two latch grooves.

In some aspects, in some examples (as depicted in FIG. 2), the pre-alignment solution encompasses the matching of first bosses 17 and first recesses 28, as well as the first magnetic attachment 11 and second magnetic attachment 21. The detachable fixation can employ the snap-fit connection described earlier, facilitating single-person assembly and disassembly. The first boss 17, torsion spring, and latch component 122 are all positioned on the matte box body 10, while the clearance notch 242 on the side of the latch groove of the mounting assembly 20 closer to the matte box body 10 allows for the unrestricted rotation of the latch component 122. The number and placement of latch components 122 ensure that they can be simultaneously operated with one or both hands. For instance, one or two latch components 122 on different side walls can be manually pressed by one user against the force of the torsion spring. During use, the mounting assembly 20 can be inverted with its recesses facing upward, enabling the user to press the latch components 122 against the force of the torsion spring to create space for alignment between the mounting assembly 20 and the matte box body 10. The first bosses 17 and first recesses 28 are then aligned and engaged, with magnetic attraction ensuring precise positioning. Releasing the latch components 122 allows the latch projections 123 to snap into the latch grooves. Alternatively, in other examples, the first bosses 17 can be substituted with second recesses 18, and the first recesses 28 with second bosses 27, achieving the same single-person assembly/disassembly effect using the same method.

To install the latch component 122, torsion spring, first magnetic attachment 11, and second magnetic attachment 21, in some examples (as shown in FIGS. 4-7), the matte box kit 100 further includes two mounting base plates 14, which are oppositely positioned on the connecting end face of the matte box body 10. One mounting base plate 14 accommodates two first bosses 17 and the first magnetic attachment 11, while the latch component 122 is rotationally connected to the mounting base plate 14 via the torsion spring and pivot shaft 124.

In some aspects, the matte box kit 100 can accommodate the installation or replacement of various optical filters 200. In some examples, filter slots 241 can be provided at the end of the matte box body 10 near the mounting assembly 20, enabling the matte box body 10 to also function as a filter holder, while the mounting assembly 20 connects the lens and matte box body 10.

Referring to FIGS. 1-3, in some embodiments, the mounting assembly 20 can include a filter mount 24 and a lens mount 25 connected along the first direction. The lens mount 25 features a through-hole, with its end facing away from the filter mount 24 used for mounting the lens. The filter mount 24 includes at least one filter slot 241, which communicates with the through-hole of the lens mount 25, collectively forming the second light path 23. The second magnetic attachment can be located on the filter mount 24, which detachably connects to the matte box body 10. When two or more filter slots 241 are present, they are stacked along the first direction. During installation, the matte box body 10, filter mount 24, lens mount 25, and lens are sequentially connected along the first direction, with the filter mount 24 positioned between the matte box body 10 and lens mount 25. The optical filter 200 can be installed on the filter mount 24, while the lens mount 25 secures the lens, fixing the entire matte box kit 100 to the lens. This arrangement simplifies the structure of the matte box body 10 while optimizing the structure and functionality of the mounting assembly 20.

The connection method between the filter mount 24 and lens mount 25 is not restricted to the described examples. They can be fixedly or detachably connected. For example, in some examples (as shown in FIGS. 2-3), the side of the filter mount 24 facing away from the matte box body 10 connects to the lens mount 25 via four screws threaded into corresponding holes on the filter mount 24. Two of these screws can be thumb screws with a clamping segment between the threaded and handheld portions to press the lens mount 25 against the filter mount 24. The diameter of the clamping segment is larger than the outer diameter of the threaded segment.

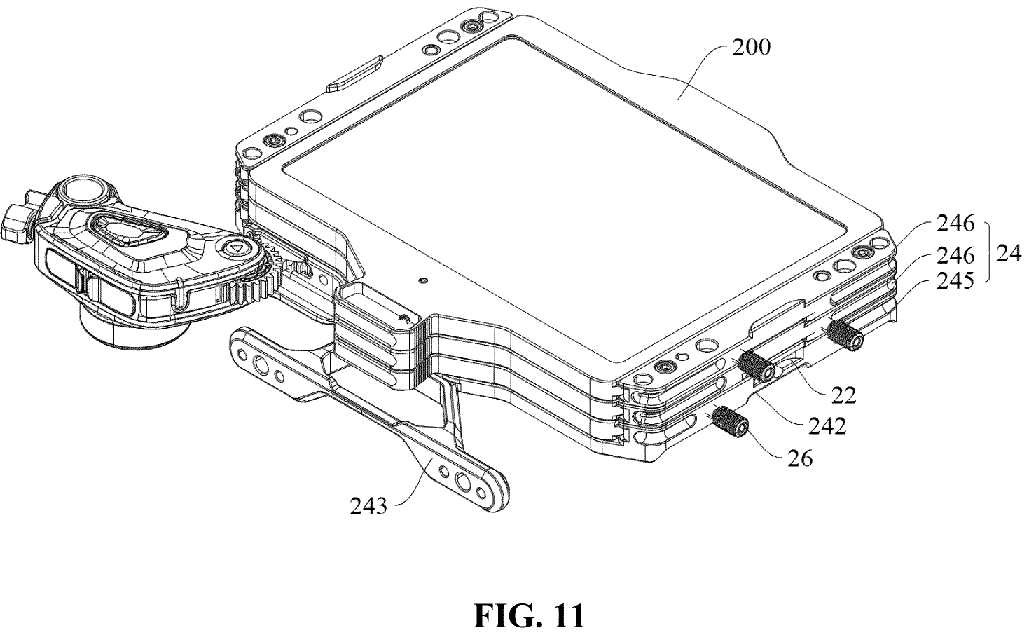

To facilitate the installation and removal of the optical filter 200, in some examples (as shown in FIGS. 11-13), a clamping member 26 can be threaded into the circumferential surface of the filter mount 24 along the first direction. The clamping member 26 can be tightened to press against the frame of the optical filter 200, securing the optical filter 200 in place after insertion into the filter slot 241.

To facilitate the preliminary positioning of the optical filter 200 prior to being locked by the clamping member 26, some examples incorporate a positioning pin 244 embedded within the inner peripheral wall of the filter slot 241. This positioning pin 244 includes a base, an elastic element, and a ball. The ball can be mounted on the base in a manner that allows it to roll, with the ends of the elastic element abutting against both the base and the ball. Notably, the ball is not rigidly connected to the elastic element, enabling it to rotate about its own axis while simultaneously compressing the elastic element. The part of the ball that is distal to the elastic element protrudes beyond the base to make contact with the optical filter 200. The optical filter 200, installed into the filter slot 241, can include a lens and a lens frame, with a positioning hole located on the side of the lens frame. This positioning hole is designed to accommodate the ball. Owing to the ball's spherical shape, when it comes into contact with other areas on the lens frame, it compresses the spring and rolls, thereby facilitating the smooth installation of the optical filter 200 into the filter slot 241. Once the optical filter 200 is correctly installed, the position of the ball aligns with that of the positioning hole, and the elastic element forces the ball into the positioning hole, thus securing the optical filter 200 in place.

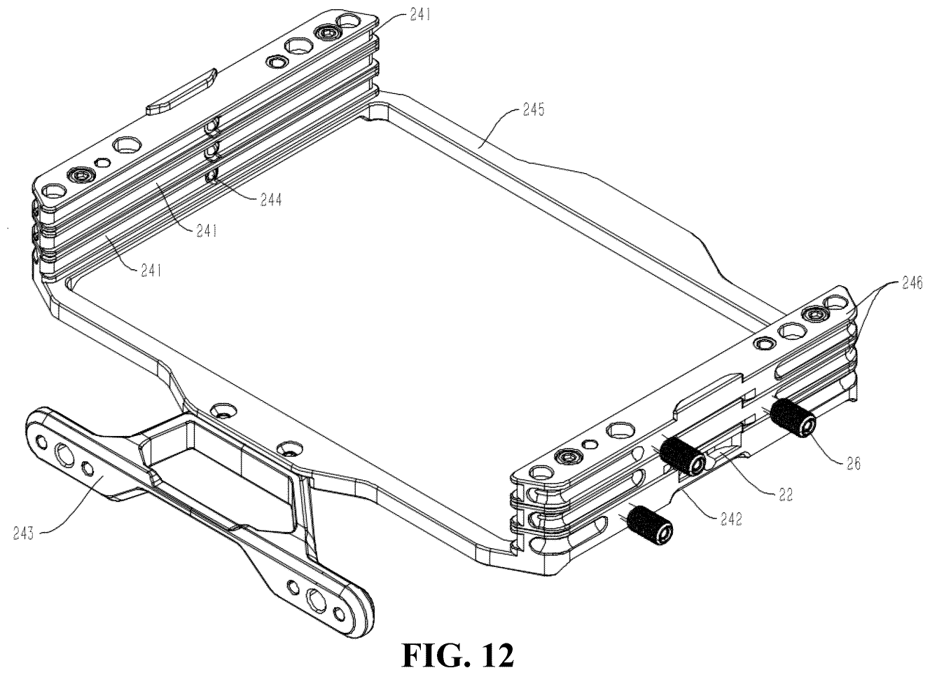

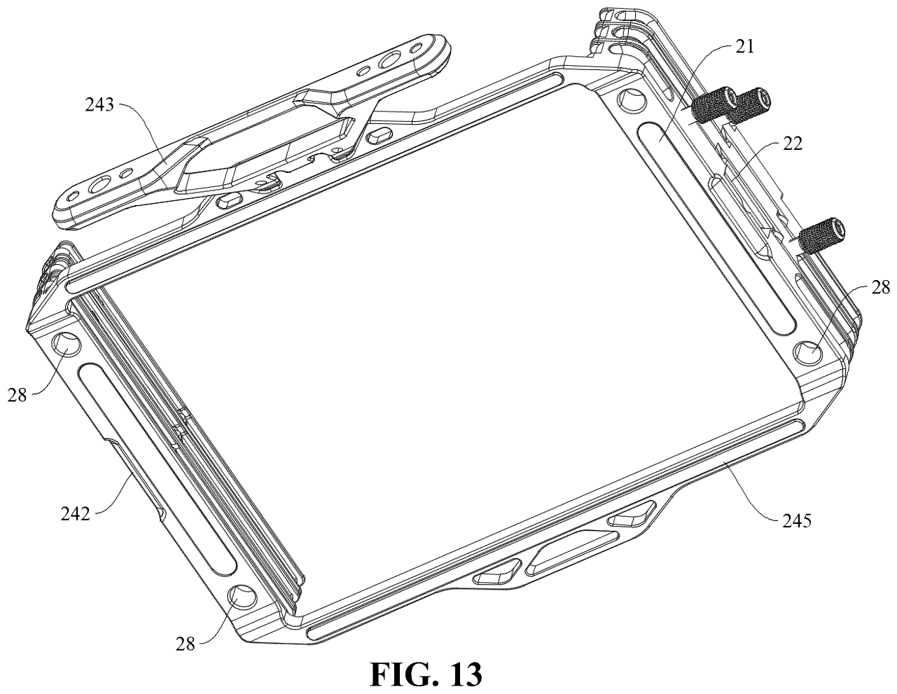

To simplify the structure and reduce the weight of the filter mount 24, in some aspects (as shown in FIGS. 12-13), the filter mount 24 is a multi-layer structure including a detachable base layer 245 and at least one sub-layer 246 stacked along the first direction. The base layer 245, positioned between the sub-layer 246 and matte box body 10, with a latch groove provided on its side, is a rectangular hollow frame with filter slots 241 on two opposing sides. The matte box body 10 can be latch-connected to the base layer 245. The sub-layer 246 includes two mounting bars, each with a filter slot 241 on one side. After aligning the directions of all filter slots 241, the adjacent base layer 245 and sub-layer 246 (e.g., one or more adjacent sub-layers 246), are positioned and then connected and fixed by threaded fasteners.

To meet diverse shooting needs, in some aspects, the matte box kit 100 can include at least one light baffle 30 movably mounted at the end of the matte box body 10 opposite the mounting assembly 20. The light baffle 30 can be deployed during shooting to block stray light.

In some aspects, the light baffle 30 can be slidably mounted on the matte box body 10 or detachably installed thereon to block the first light path 13 when not in use.

In some aspects, to mount the light baffle 30 assembly, the outer peripheral surface of the matte box body 10 can be provided with a threaded support bracket 16, and the light baffle 30 includes a connection shaft 31. The matte box kit 100 can include a mounting block 40 and a locking screw 50. One end of the mounting block 40 is fixed to the threaded support bracket 16, while the other end is rotatably coupled to the connection shaft 31. The locking screw 50 selectively locks or releases the connection shaft 31 and the mounting block 40, enabling the light baffle 30 to switch between an angle-adjustable state and a fixed-position state. Through the cooperation of the threaded support bracket 16, mounting block 40, and locking screw 50, the light baffle 30 is rotationally mounted at the end of the first light path 13 opposite the second light path 23. When the locking screw 50 secures the connection shaft 31 and the mounting block 40, the light baffle 30 cannot rotate. When the locking screw 50 creates a gap between the mounting block 40 and the connection shaft 31, the light baffle 30 becomes rotatable.

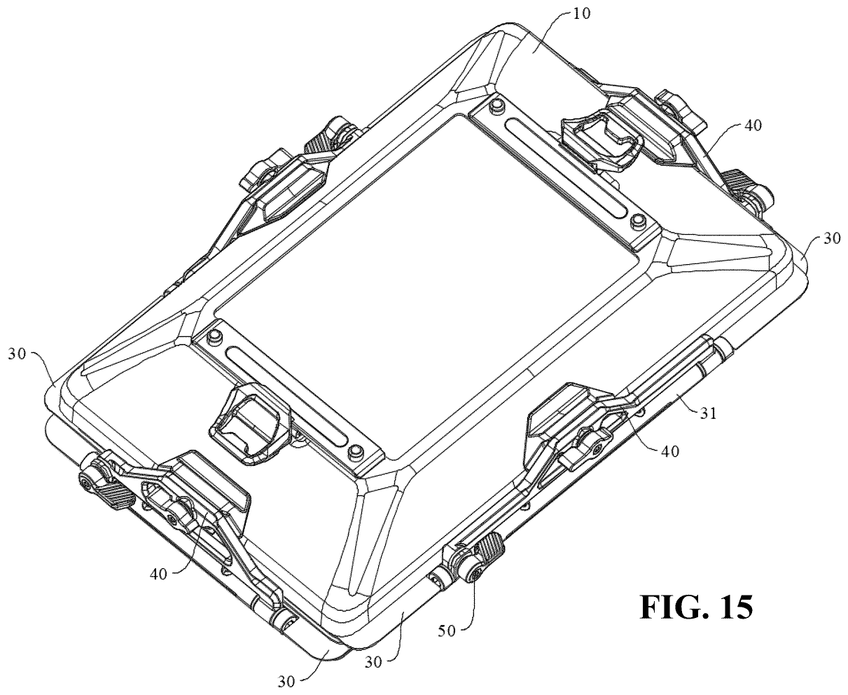

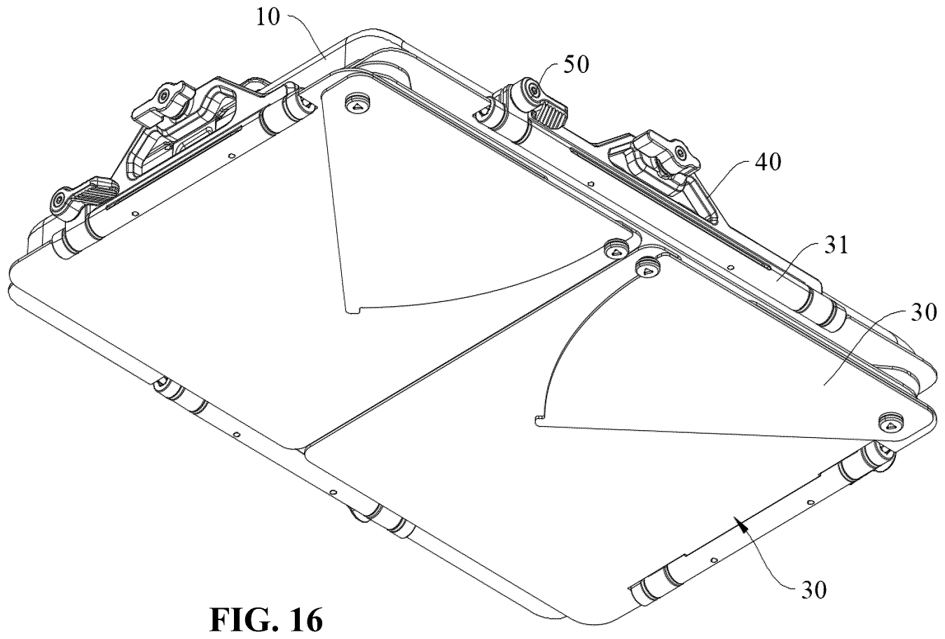

In some aspects (as shown in FIGS. 15-18), four light baffles 30 are provided, and the outer peripheral surface of the matte box body 10 correspondingly includes four spaced threaded support brackets 16. Along the circumferential direction of the matte box body 10, the four rotating components are arranged at intervals, with the rotation shafts of adjacent components perpendicular to each other.

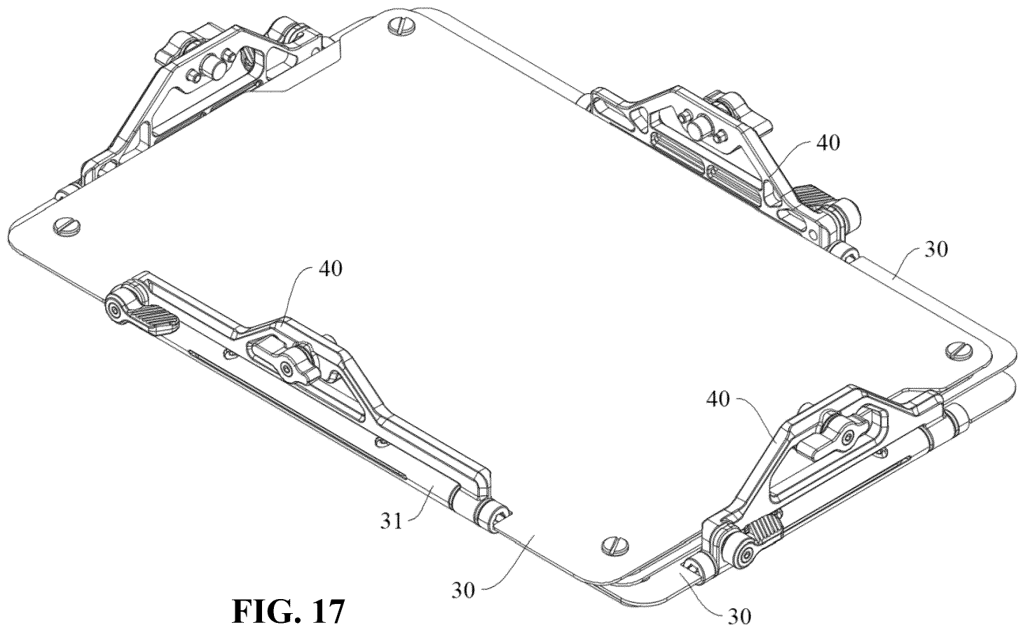

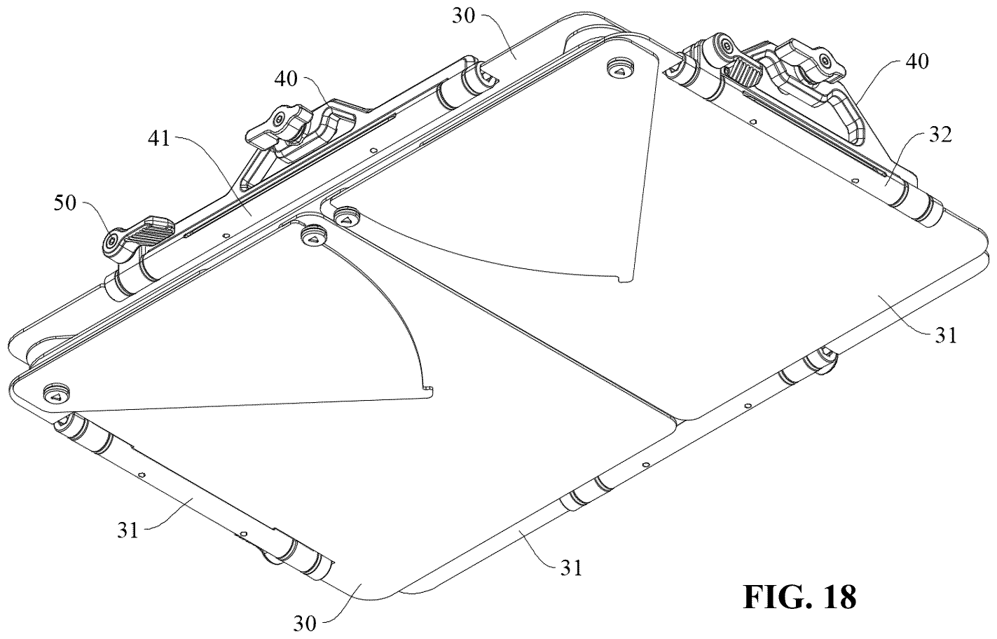

In some aspects, the light baffle 30 and the connection shaft 31 can be integrally formed. For ease of assembly (as shown in FIGS. 17-18), the light baffle 30 and the connection shaft 31 can be connected via an interference fit and secured with fasteners to facilitate connection with the mounting block 40.

Referring to FIG. 12, in some aspects, the mounting assembly 20 includes a mounting bracket 243 with multiple spaced threaded interfaces for attaching accessories such as extension brackets or lighting equipment to provide illumination.

In some aspects (as shown in FIGS. 1, 2, and 8), the mounting bracket 243 and the threaded support bracket 16 can cooperate with each other. The mounting bracket 243 extends to the position of the threaded support bracket 16, with its central portion recessed. The threaded support bracket 16 includes a clamping portion that engages with the recessed structure. The end of the mounting block 40 away from the connection shaft 31 features a protruding structure matching the recess, allowing the clamping portion to avoid interference with the recess while assisting in aligning the mounting assembly 20 and the matte box body 10.

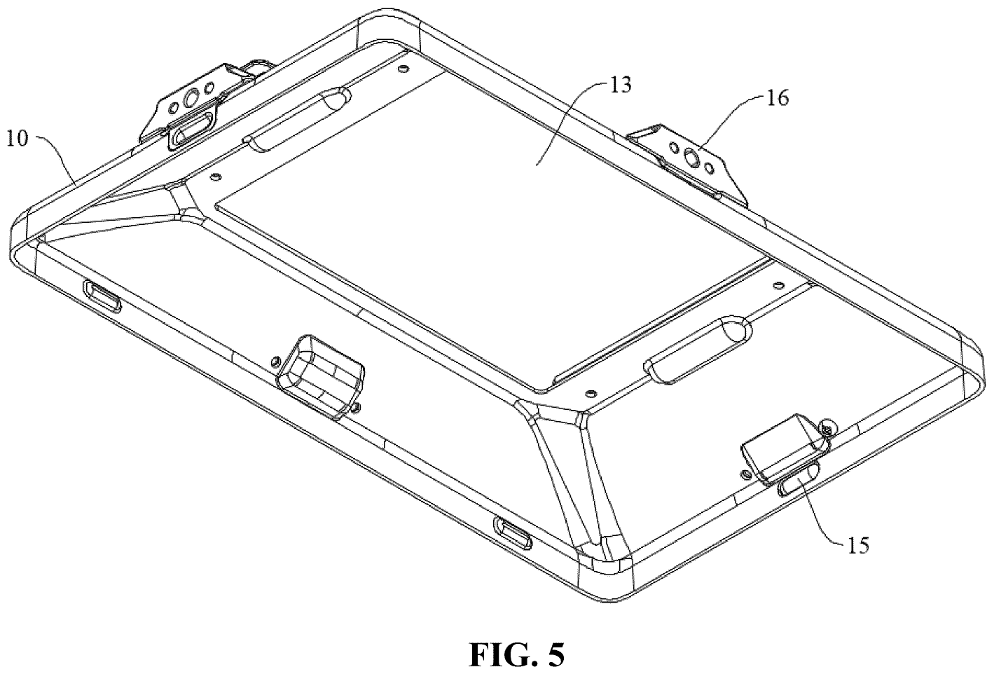

To fulfill high-quality photography demands, a hard matte can be installed within the first light path 13 of the matte box body 10 to obstruct stray light. In some aspects (as depicted in FIG. 5), the matte box body 10 features an inner cavity with an opening oriented away from the mounting assembly 20 and a light-passing hole facing towards the mounting assembly 20. This light-passing hole connects with the inner cavity along the first direction, thereby forming the first light path 13. The matte box kit 100 also includes the hard matte, which is installed inside the inner cavity of the matte box body 10. A limiting part 15 is provided on the inner wall of the cavity to prevent the hard matte from disengaging, ensuring a stable installation while simplifying the structure of the matte box body 10. Note that the hard matte is not illustrated in FIG. 5; the light-passing hole refers to the section of the first light path 13 adjacent to the mounting assembly 20. Along the first direction, the majority of the first light path 13 that faces away from the mounting assembly 20 can be considered as the inner cavity of the matte box body 10, encompassing at least the section designated for securing the hard matte.

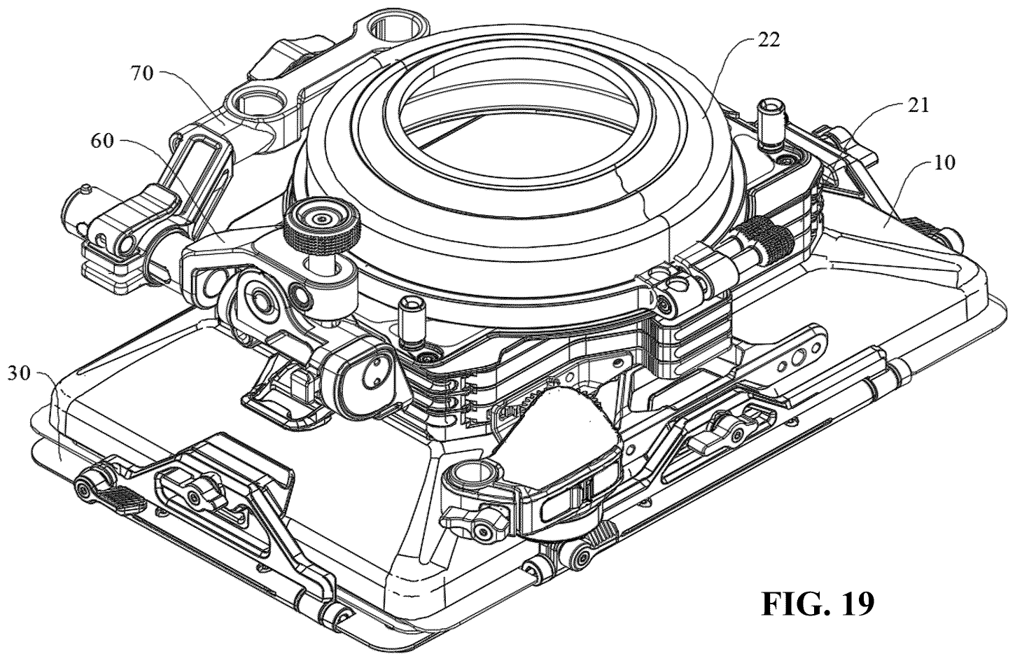

In practical applications, the matte box kit 100 can be paired with external structures like gimbal kits or stabilizer kits. In some aspects (as shown in FIGS. 19-22), the matte box kit 100 can include an angle adjustment apparatus 60, which includes a first connector 61, a second connector 62, and an adjustment assembly 63. The second connector 62 is affixed to either the matte box body 10 or the mounting assembly 20 and is rotatably connected to the first connector 61, which is used to attach the matte box kit 100 to an external structure. The adjustment assembly 63 includes a first adjustment pivot 631, a second adjustment pivot 632, and an adjuster 633. The first adjustment pivot 631 is rotatably mounted on the first connector 61, while the second adjustment pivot 632 is rotatably mounted on the second adjuster 633. Both the first adjustment pivot 631 and the second adjustment pivot 632 are parallel to the rotation axis of the second connector 62. The adjuster 633 is threadedly connected to at least one of the pivots and adjusts the angle between the first connector 61 and the second connector 62 when rotated. By turning the adjuster 633, the distance between the first and the second adjustment pivots 631 and 632 can be modified, thereby altering the relative angle between the first connector 61 and the second connector 62, thereby causing relative rotation between the first connector 61 and the second connector 62, which enables the matte box kit 100 connected to the second connector 62 to be positioned at different angles relative to the first connector 61 and enables the matte box kit 100 to be adjusted to various orientations as required.

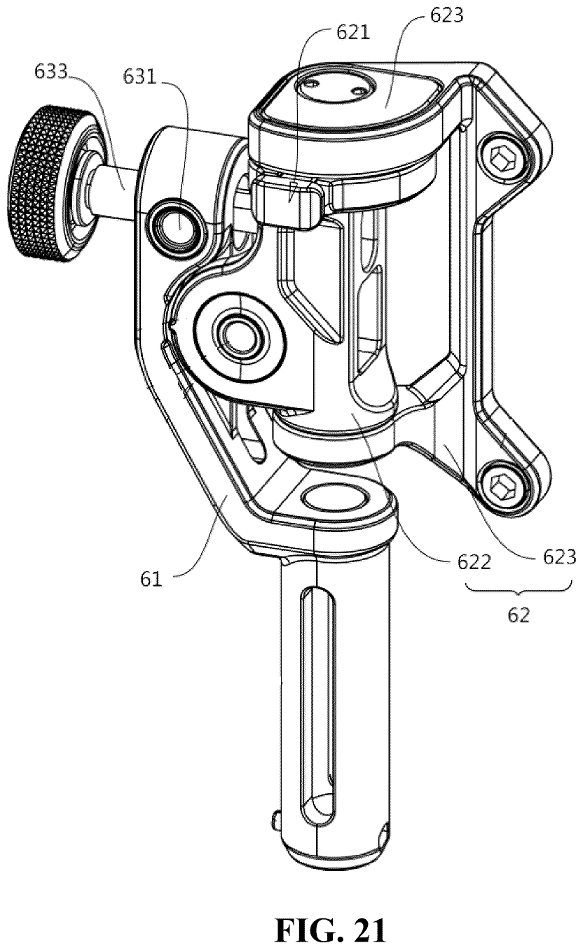

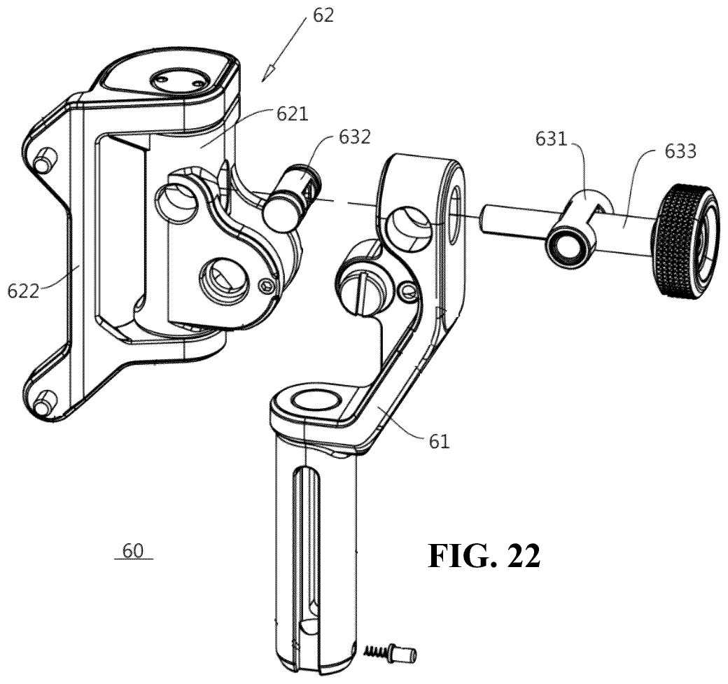

In some aspects, with reference to FIGS. 21-22, to facilitate the replacement of accessories on the matte box kit 100, the second connector 62 comprises a limit stop 621, a first link unit 622, and a second link unit 623. The second link unit 623 is rotatably connected to the first link unit 622, with the rotation axis between the second link unit 623 and the first link unit 622 being perpendicular to that between the first link unit 622 and the first connector 61. The limit stop 621 is designed to lock or unlock the rotational state between the first link unit 622 and the second link unit 623. The limit stop 621 is movably positioned on either the first link unit 622 or the rotational connection portion and can switch between unlocked and locked states. When locked, the second link unit 623 is fixed to the first link unit 622; when unlocked, the second link unit 623 can rotate relative to the first link unit 622. This configuration enables the adjustment of the position of the second link unit 623 relative to the first link unit 622 when replacing accessories on the matte box kit 100, thereby providing greater operational space for the installation and replacement of required components.

For instance, in some aspects, the limit stop 621 can be an elastically retractable limit button located on the first link unit 622, while the second link unit 623 is equipped with a limit slot. Pressing the limit button disengages it from the limit slot, allowing the second link unit 623 to rotate relative to the first link unit 622. This setup enables the adjustment of the limit stop 621 to the unlocked state when installing or replacing accessories on the matte box kit 100, permitting the second link unit 623 to be rotated to the desired position. After replacement, the second link unit 623 can be returned to its original position, and the limit stop 621 reset to the locked state, restoring the angle adjustment apparatus of the matte box kit 100 to normal operation. This design not only facilitates accessory installation and replacement but also effectively prevents unintended deflection of the second link unit 623 during use.

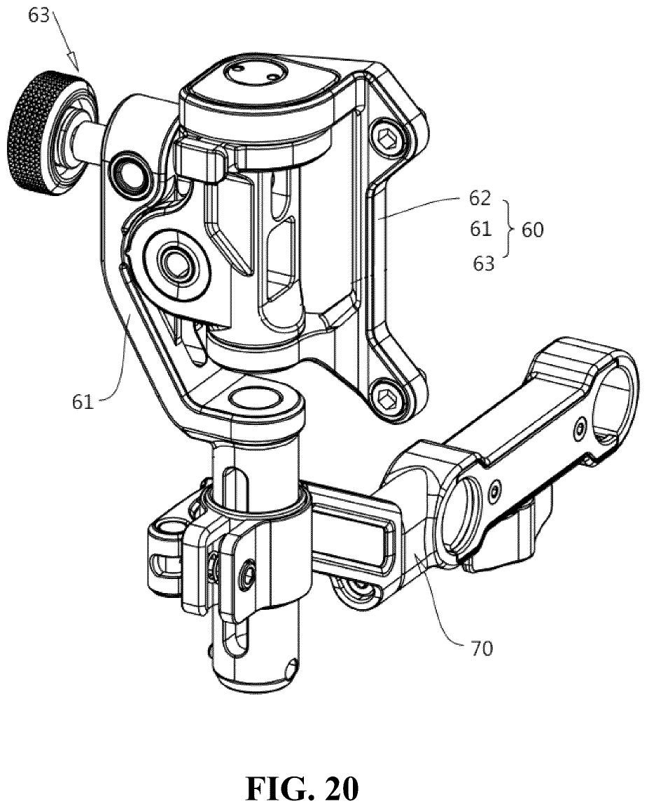

In some aspects, to ensure a stable connection between external structures and the angle adjustment apparatus 60, the matte box kit 100 can include a clamping structure 70. With reference to FIGS. 20, 23, and 24, the clamping structure 70 includes a main bracket 71 and a linkage assembly 72. One end of the main bracket 71 features a clamp holder 711, while the opposite end features a mounting groove 712. The first connector 61 is installed in the clamp holder 711. The linkage assembly 72 includes a locking block 721 and a linkage adjuster 722. The locking block 721 is slidably positioned within the mounting groove 712, and the linkage adjuster 722 is mounted on the main bracket 71. The output end of the linkage adjuster 722 is drivingly connected to the locking block 721 to drive its sliding motion within the mounting groove 712, thereby pressing the connection portion of the external structure against the groove wall of the mounting groove 712.

The present disclosure does not restrict the specific implementation of the linkage adjuster 722, which can adopt any feasible solution. For example, in some examples, the linkage adjuster 722 can be a bolt threaded into the main bracket 71, with its axial direction aligned with the sliding direction of the locking block 721 in the mounting groove 712, thereby pushing the locking block 721. In other examples, the linkage adjuster 722 can adopt a ball screw structure, where the locking block 721 connects to the linear motion component of the ball screw to drive its sliding along the mounting groove 712. In some aspects, any structure capable of altering the position of the locking block 721 within the mounting groove 712 can serve as the linkage adjuster 722.

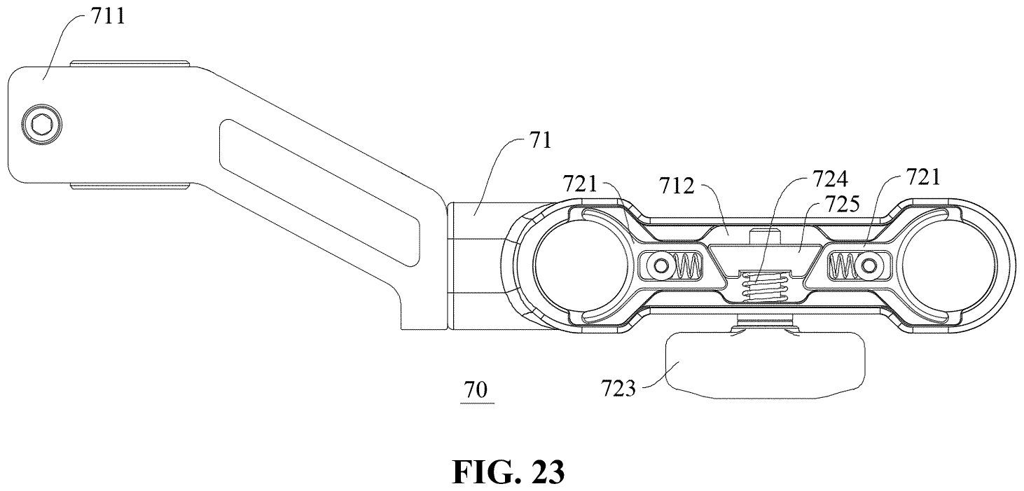

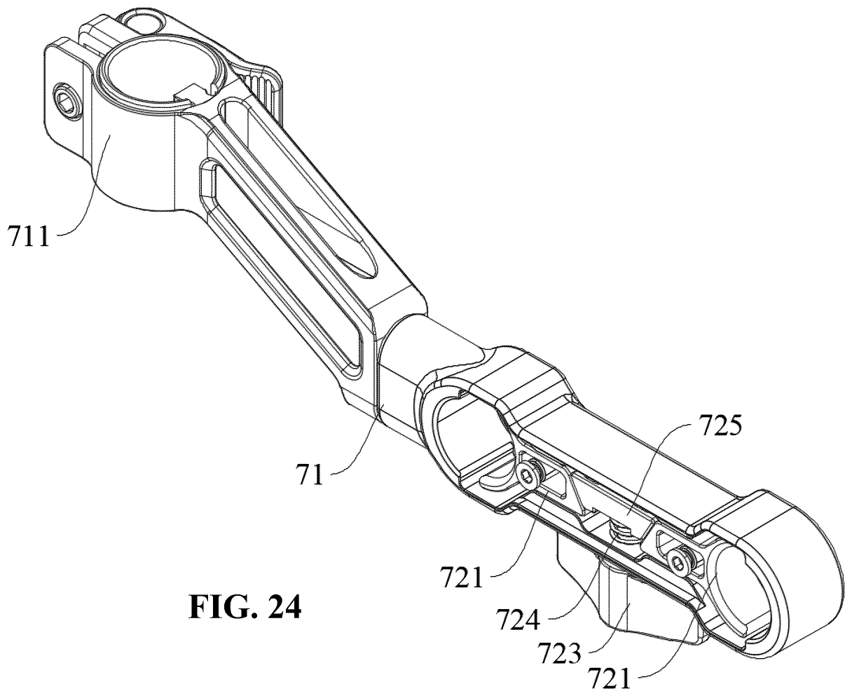

In some aspects, with reference to FIGS. 23 and 24, both ends of the mounting groove 712 are configured as through circular holes suitable for connecting tubular external structures. Two locking blocks 721 are provided, with their ends adjacent to the circular holes shaped as semicircular arcs to form clamping surfaces matching the tubular connection. The opposite ends of the locking blocks 721 feature inclined guide surfaces. The linkage adjuster 722 includes a locking knob 723, a spring 724, and a linkage block 725. The locking knob 723 is threaded into the main bracket 71 with one end extending into the mounting groove 712. The linkage block 725 is positioned within the mounting groove 712 between the two locking blocks 721. Along the sliding direction of the locking blocks 721, both ends of the linkage block 725 have contact surfaces that cooperate with the guide bevels of the locking blocks 721. The linkage block 725 is threaded onto the shaft of the locking knob 723, and the spring 724 is sleeved over the shaft, acting between the linkage block 725 and the groove wall of the mounting groove 712. When the locking knob 723 is rotated, the linkage block 725 cannot rotate due to the interaction between the guide bevels and contact surfaces, causing it to move relative to the locking knob 723 and thereby push the locking blocks 721 apart to clamp the external structure (e.g., connecting circular tube). The spring 724 between the linkage block 725 and groove wall ensures structural stability. Without this spring 724, the system could become loose and unstable due to a lack of tension between the linkage block 725 and the groove wall of the mounting groove 712.

The “external structure” mentioned in this disclosure can refer to a stabilizer or gimbal, or alternatively a stabilizer or gimbal equipped with mounting provisions for the clamping structure 70. In summary, any structural component capable of mounting the matte box kit 100 of this disclosure can be considered an external structure.

The matte box kit 100 provided by the present disclosure offers at least the following advantages:

1. The first magnetic attachment 11 on the matte box body 10 and the second magnetic attachment 21 on the mounting assembly 20 are mutually adapted. Under the magnetic attraction between opposite poles, rapid pre-alignment and pre-connection can be achieved, reducing manual handling requirements and lowering assembly difficulty to a some extent. Subsequent alignment and detachable fixation between the first connection structure 12 and second connection structure 22 complete the assembly of the matte box kit 100. The mounting assembly 20 connects and secures to the lens, enabling the installation of the entire matte box kit 100 onto the lens and alignment of the first light path 13 and second light path 23 with the lens. The matte box kit 100 achieves a rapid assembly/disassembly solution through sequential pre-alignment, pre-connection, and detachable fixation, demonstrating technical effects of convenient assembly and case of use.

2. The matte box body 10 incorporates a latch component 122 connected via a torsion spring, while the filter mount 24 features a latch groove. The latch projection 123 of the latch component 122 can engage with the latch groove for quick installation. The adjacent end faces of the matte box body 10 and filter mount 24 are respectively provided with the first magnetic attachment 11 and second magnetic attachment 21 for magnetic positioning, enabling pre-alignment and pre-connection between the matte box body 10 and filter mount 24 prior to detachable connection.

As used in the claims, the indefinite articles “a” and “an” should be understood to mean “one or more” unless explicitly stated otherwise or unless the context clearly dictates a singular interpretation. The use of these articles does not limit the claimed invention to a single instance of the referenced element but rather encompasses multiple instances where applicable.

What is claimed is:

1. A matte box kit, comprising:
a matte box body comprising a first connection structure and defining a first light path penetrating along a first direction;
a mounting assembly configured for mounting a lens, wherein the mounting assembly has a second connection structure and defines a second light path penetrating along the first direction;
a first magnetic attachment provided on the matte box body; and
a second magnetic attachment provided on the mounting assembly;
wherein the first magnetic attachment and the second magnetic attachment are mutually attracted to pre-align and pre-connect the matte box body and the mounting assembly; and
wherein the first connection structure and the second connection structure form a detachable fixation for the first light path, the second light path, and the lens to be opposed and communicated along the first direction.

2. The matte box kit according to claim 1, wherein the matte box body further comprises one or more first bosses, and the mounting assembly further comprises one or more first recesses; and
wherein each the first bosses corresponds to a respective one of the first recesses; and
wherein the matte box body further comprises one or more second recesses, and the mounting assembly further comprises one or more second bosses; and
wherein each of the second recesses corresponds to a respective one the second bosses.

3. The matte box kit according to claim 1, wherein the matte box body further comprises one or more first bosses, and the mounting assembly further comprises one or more first recesses; and
wherein each the first bosses corresponds to a respective one of the first recesses.

4. The matte box kit according to claim 1, wherein the matte box body further comprises one or more second recesses, and the mounting assembly further comprises one or more second bosses; and
wherein the matte box body further comprises one or more second recesses, and the mounting assembly further comprises one or more second bosses; and
wherein each of the second recesses corresponds to a respective one the second bosses.

5. The matte box kit according to claim 1, wherein the first connection structure comprises a plurality of the first connection structures and the second connection structure comprises a plurality of second connection structures,
wherein two of the first connection structures are oppositely provided on the matte box body and located on two sides of the first light path; and
wherein two of the second connection structures are oppositely provided on two opposite sides of the mounting assembly.

6. The matte box kit according to claim 1, wherein the first connection structure comprises an elastic member and a latch component;
wherein the latch component is movably provided on the matte box body and is provided with a latch projection;
wherein the second connection structure comprises a latch groove; and
wherein the elastic member is configured to act on the latch component to engage the latch projection into the latch groove and prevent disengagement of the latch projection from the latch groove.

7. The matte box kit according to claim 6, wherein the latch component is further provided with a limit projection, and the mounting assembly is further provided with a limit slot;
wherein the limit slot communicates with the latch groove;
wherein, along the first direction, the limit projection is provided on a side of the latch projection closer to the matte box body, and the limit slot is provided on a side of the latch groove closer to the matte box body;
wherein the length of latch groove is greater than the length of the limit slot to form a stepped surface along the first direction; and
wherein the limit slot matches the limit projection in terms of length to position the limit projection within the limit slot.

8. The matte box kit according to claim 6, wherein the latch projection is provided with a guide bevel on a side facing away from the matte box body; and
wherein an end of the guide bevel closer to the first light path is provided closer to the matte box body along the first direction than an end of the guide bevel facing away from the first light path;
wherein the matte box body is further provided with a stop rib at an end facing the mounting assembly;
wherein the stop rib is located on a side of the latch component closer to the first light path, and the stop rib is configured to restrict the latch component from rotating toward a center of the first light path after reset;
wherein the mounting assembly is provided with a clearance notch at an end facing the matte box body to accommodate the stop rib; and
wherein, in response to the matte box body being connected to the mounting assembly, a groove surface of the clearance notch acts on the guide bevel extending into the clearance notch to rotate the latch component away from the center of the first light path, thereby enabling installation of the matte box body and the mounting assembly.

9. The matte box kit according to claim 1, wherein the mounting assembly comprises a filter mount and a lens mount;
wherein the second magnetic attachment is provided on the filter mount, and the filter mount forms a detachable connection with the matte box body;
wherein, along the first direction, the filter mount is provided with one or more filter slots, the lens mount is connected to an end of the filter mount facing away from the matte box body, and the lens mount is provided with a through hole communicating with the one or more filter slots;
wherein the one or more filter slots and the through hole constitute the second light path; and
wherein the lens mount is configured for mounting the lens.

10. The matte box kit according to claim 1, further comprising one or more light baffles movably provided at an end of the matte box body facing away from the mounting assembly;
wherein an outer peripheral surface of the matte box body is provided with a threaded support bracket, and the one or more light baffles are provided with a pivot shaft;
wherein the matte box kit further comprises a mounting block and a locking screw;
wherein a first end of the mounting block is fixed to the threaded support bracket, and a second end is rotatably connected to the pivot shaft; and
wherein the locking screw is configured to lock or release the pivot shaft and the mounting block, thereby switching the one or more light baffles between an angle-adjustable state and a fixed-position state.

11. The matte box kit according to claim 1, wherein the mounting assembly is provided with a mounting bracket provided with multiple threaded interfaces spaced apart; and
wherein the matte box body is provided with an inner cavity with an opening facing away from the mounting assembly, and a light-passing hole with an opening facing the mounting assembly;
wherein the light-passing hole and the inner cavity are opposed and communicated along the first direction to form the first light path;
wherein the matte box kit further comprises a hard matte mounted in the inner cavity of the matte box body; and
wherein an inner wall of the inner cavity is provided with a limiting part configured to prevent the hard matte disengaging from the matte box body.

12. The matte box kit according to claim 1, wherein the mounting assembly is provided with a mounting bracket provided with multiple threaded interfaces spaced apart.

13. The matte box kit according to claim 1, wherein the matte box body is provided with an inner cavity with an opening facing away from the mounting assembly, and a light-passing hole with an opening facing the mounting assembly;
wherein the light-passing hole and the inner cavity are opposed and communicated along the first direction to form the first light path;
wherein the matte box kit further comprises a hard matte mounted in the inner cavity of the matte box body; and
wherein an inner wall of the inner cavity is provided with a limiting part configured to prevent the hard matte disengaging from the matte box body.

14. The matte box kit according to claim 1, further comprising an angle adjustment apparatus, wherein the angle adjustment apparatus comprises:
a first connector configured for mounting the matte box kit to an external structure;
a second connector fixedly connected to the matte box body or the mounting assembly, wherein the second connector is rotatably connected to the first connector; and
an adjustment assembly comprising a first adjustment pivot, a second adjustment pivot, and an adjuster; and
wherein the first adjustment pivot is rotatably provided on the first connector, the second adjustment pivot is rotatably provided on the second connector, and the adjuster is threadedly connected to at least one of the first adjustment pivot and the second adjustment pivot to adjust an angle between the first connector and the second connector in response to a rotation of the adjuster.

15. The matte box kit according to claim 14, further comprising a clamping structure, wherein the clamping structure comprises:
a main bracket provided with a clamp holder at a first end and a mounting groove at a second end;
wherein the first connector is mounted to the clamp holder; and
a linkage assembly comprising a locking block and a linkage adjuster;
wherein the locking block is slidably provided in the mounting groove; and
wherein the linkage adjuster is provided on the main bracket, and an output end of the linkage adjuster is drivingly connected to the locking block to drive the locking block to slide in the mounting groove, thereby pressing a connection part of the external structure against a groove wall of the mounting groove.
